(19) United States
(12) Patent Application Publication
(10) Pub. No.: US 2019/0087793 A1
(43) Pub. Date: Mar. 21, 2019

(54) ADDING CONCURRENCY TO SMART CONTRACTS

(71) Applicant: BROWN UNIVERSITY, Providence, RI (US)

(72) Inventors: Thomas Dickerson, Providence, RI (US); Paul Gazzillo, Titusville, NJ (US); Maurice Herlihy, Brookline, MA (US); Eric Koskinen, New York, NY (US)

(21) Appl. No.: 16/119,750

(22) Filed: Aug. 31, 2018

Related U.S. Application Data
(60) Provisional application No. 62/553,019, filed on Aug. 31, 2017.

(51) Int. Cl. G06Q 20/06; H04L 29/08; G06Q 20/36; H04L 9/06

(52) U.S. Cl. CPC G06Q 20/0658; H04L 9/0637; G06Q 20/3672; H04L 67/327

(57) ABSTRACT

A method and apparatus for adding concurrency to smart contracts. An information processing system includes a user device supporting a cryptocurrency user, cryptocurrency vendor devices, the cryptocurrency vendor devices comprising processing devices of one or more cryptocurrency vendors that offers an amount of cryptocurrency for sale to the cryptocurrency user, blockchain processing devices, the blockchain processing devices comprising processing devices of one or more cryptocurrency miners that perform processing operations to maintain a public ledger in a form of a blockchain characterizing transactions involving a particular cryptocurrency, the blockchain processing devices enabling miners to speculatively execute smart contracts in parallel using atomic transactions through hardware and/or software to permit non-conflicting smart contracts to execute concurrently, a processing platform associated with a financial institution that provides payment mechanisms, and a network coupling the user device, cryptocurrency vendor devices, blockchain processing devices and the processing platform.

### STATEMENT REGARDING GOVERNMENT INTEREST

This invention was made with government support under Grant No. CCF-1420673 awarded by the National Science Foundation. The government has certain rights in the invention.

### CROSS REFERENCE TO RELATED APPLICATIONS

This application claims benefit from U.S. Provisional Patent Application Ser. No. 62/553019, filed Aug. 31, 2017, which is incorporated by reference in its entirety.

### BACKGROUND OF THE INVENTION

The present invention relates generally to cryptocurrencies, and more particularly to techniques for adding concurrency to smart contracts.

In general, cryptocurrency is a medium of exchange like normal currencies such as United States Dollars (USD), but designed for the purpose of exchanging digital information through a process made possible by certain principles of cryptography. More specifically, cryptocurrency is an encrypted decentralized digital currency transferred between peers and confirmed in a public ledger by a process known as mining.

Unlike traditional currencies, cryptocurrency is decentralized. Instead of one entity (such as a bank or central government) controlling the creation of money and keeping track of the ledger and accounts, each member of the community (each account holder) contributes to a single, public ledger of transactions and each member can create money through confirming transactions.

When a transaction is made, the spender and receiver each use a unique digital signature. A digital signature uses a public key (to create a signature and to send money to) and private key (used by others to verify the signature) that can be used to legitimize the transaction. This helps ensure that transactions are recorded correctly and that the spender owns the money they're trying to spend. Time stamping helps to ensure that the order of transactions is chronological. This is done by placing a group of transactions in a “block” that gets appended to the coin's ledger. Everything in that block is considered to happen at the same time. Once a block is recorded, it is permanent and publicly visible.

The entity that verifies the transaction and adds it to the ledger is called a “miner.” This is because when a transaction is added to the ledger, new coins are created and given to the entity as part of the fee.

Modern cryptocurrency systems permit complex financial transactions through scripts called smart contracts. These smart contracts are executed many, many times, always without real concurrency. First, all smart contracts are serially executed by miners before appending them to the blockchain. Later, those contracts are serially re-executed by validators to verify that the smart contracts were executed correctly by miners. Serial execution limits system throughput and fails to exploit today's concurrent multicore and cluster architectures. Nevertheless, serial execution appears to be required, i.e., contracts share state, and contract programming languages have a serial semantics.

What is needed is a way to permit miners and validators to execute smart contracts in parallel.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an information processing system including a user device supporting a cryptocurrency user, cryptocurrency vendor devices, the cryptocurrency vendor devices comprising processing devices of one or more cryptocurrency vendors that offers an amount of cryptocurrency for sale to the cryptocurrency user, blockchain processing devices, the blockchain processing devices comprising processing devices of one or more cryptocurrency miners that perform processing operations to maintain a public ledger in a form of a blockchain characterizing transactions involving a particular cryptocurrency, the blockchain processing devices enabling miners to speculatively execute smart contracts in parallel using atomic transactions through hardware and/or software to permit non-conflicting smart contracts to execute concurrently, a processing platform associated with a financial institution that provides payment mechanisms, and a network coupling the the user device, cryptocurrency vendor devices, blockchain processing devices and the processing platform.

In another aspect, the invention features a method including providing an information processing system, the information processing system including a user device supporting a cryptocurrency user, cryptocurrency vendor devices, the cryptocurrency vendor devices comprising processing devices of one or more cryptocurrency vendors that offers an amount of cryptocurrency for sale to the cryptocurrency user, blockchain processing devices, the blockchain processing devices comprising processing devices of one or more cryptocurrency miners that perform processing operations to maintain a public ledger in a form of a blockchain characterizing transactions involving a particular cryptocurrency, a processing platform associated with a financial institution that provides payment mechanisms, a network coupling the user device, cryptocurrency vendor devices, blockchain processing devices and the processing platform, and enabling miners to speculatively execute smart contracts in parallel using atomic transactions through hardware and/or software to permit non-conflicting smart contracts to execute concurrently.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary information processing system.

FIG. 2 is an exemplary Solidity language listing.

FIG. 3 is an exemplary Solidity language listing.

FIG. 4 is an exemplary Solidity language listing.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Some of the following terms are useful to understanding the present invention.

### Public Ledgers

All confirmed transactions from the start of a cryptocurrency's creation are stored in a public ledger. The identities of the coin owners are encrypted, and the system uses other cryptographic techniques to ensure the legitimacy of record keeping. The ledger ensures that corresponding “digital wallets” can calculate an accurate spendable balance. Also, new transactions can be checked to ensure that each transaction uses only coins currently owned by the spender. Bitcoin calls this public ledger a “transaction blockchain.”

### Transactions

A transfer of funds between two digital wallets is called a transaction. That transaction gets submitted to a public ledger and awaits confirmation. When a transaction is made, wallets use an encrypted electronic signature (an encrypted piece of data called a cryptographic signature) to provide a mathematical proof that the transaction is coming from the owner of the wallet. The confirmation process takes a bit of time (ten minutes for bitcoin) while “miners” mine (i.e., confirm transactions and add them to the public ledger).

### Mining

In simple terms, mining is the process of confirming transactions and adding them to a public ledger. In order to add a transaction to the ledger, the “miner” must solve an increasingly-complex computational problem (sort of like a mathematical puzzle). Mining is open source, so anyone can confirm the transaction. The first “miner” to solve the puzzle adds a “block” of transactions to the ledger. The way in which transactions, blocks, and the public blockchain ledger work together ensures that no one individual can easily add or change a block at will. Once a block is added to the ledger, all correlating transactions are permanent and a small transaction fee is added to the miner's wallet (along with newly created coins). The mining process is what gives value to the coins and is known as a proof-of-work system.

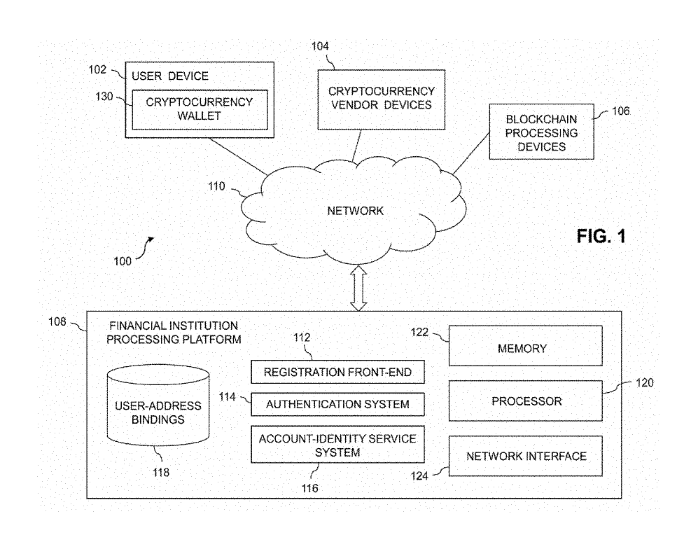

As shown in FIG. 1, an exemplary information processing system 100 includes a user device 102, cryptocurrency vendor devices 104, blockchain processing devices 106, and a processing platform 108, all of which are coupled to a network 110.

The user device 102 includes a laptop, tablet or desktop personal computer, a mobile telephone, or another type of computer or processing device associated with a given cryptocurrency user within the system 100. Although only a single user device 102 is shown in FIG. 1, the system 100 may include multiple such devices each associated with a different cryptocurrency user.

The cryptocurrency vendor devices 104 include respective computers or other processing devices of one or more cryptocurrency vendors. A given such “cryptocurrency vendor” as the term is broadly used herein is intended to encompass any entity that offers an amount of cryptocurrency for sale to a cryptocurrency user.

The blockchain processing devices 106 include respective computers or other processing devices of one or more cryptocurrency “miners” or other blockchain processing entities. Such entities perform processing operations in order to maintain a public ledger in the form of a blockchain characterizing transactions involving a particular cryptocurrency. A given blockchain processing entity may additionally be a cryptocurrency user and/or a cryptocurrency vendor.

The processing platform 108 may be associated with a financial institution such as a bank or other issuer of credit cards, debit cards or other types of payment cards or more generally payment mechanisms.

The processing platform 108 may be implemented within a physical facility of a given financial institution. Alternatively, the processing platform 108 may be maintained by another entity, such as, for example, a cloud service provider. In such an arrangement, the financial institution may be a tenant of the cloud service provider. In other embodiments, the processing platform 108 need not be associated with any particular financial institution, but could instead be associated with another type of entity, such as a given business enterprise or other organization that provides secure cryptocurrency purchase functionality on behalf of multiple otherwise-unrelated financial institutions.

The network 110 may include, for example, a global computer network such as the Internet, a wide area network (WAN), a local area network (LAN), a satellite network, a telephone or cable network, a cellular network, a wireless network implemented using a wireless protocol such as WiFi or WiMAX, or various portions or combinations of these and other types of communication networks.

The processing platform 108 includes a registration front-end 112, an authentication system 114, an account-identity service system 116, and a database 118 that stores bindings between user identity information and respective cryptocurrency addresses for users of an address-based cryptocurrency. Such bindings are also referred to herein as “user-address bindings.” The term “binding” as used herein is intended to be broadly construed to encompass a wide variety of different techniques for establishing an association within a processing platform between user identity information and a cryptocurrency address of the corresponding user.

The processing platform 108 further includes a processor 120, a memory 122 and a network interface 124.

The processor 120 may include, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of processing circuitry, in any combination.

The memory 122 stores software program code for execution by the processor 120 in implementing portions of the functionality of the processing platform 108. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, read-only memory (ROM), magnetic memory, optical memory, or other types of storage devices in any combination.

Articles of manufacture including such processor-readable storage media are considered embodiments of the invention. The term “article of manufacture” as used herein should be understood to exclude transitory, propagating signals. A wide variety of other types of computer program products including processor-readable storage media can be implemented in other embodiments.

In FIG. 1, at least portions of the registration front-end 112, authentication system 114 and account-identity service system 116 are implemented in the form of software that is stored by memory 122 and executed by processor 120.

The network interface 124 illustratively includes one or more network interface cards, transceivers or other types of circuitry utilized to interface the processing platform 108 with the user device 102 and cryptocurrency vendor devices 104 over the network 110.

The registration front-end 112 is illustratively configured to support registration by the cryptocurrency users of their user identity information in association with respective cryptocurrency addresses of those users. The registration front-end 112 is also assumed to be configured to support registration by multiple cryptocurrency vendors as respective authorized cryptocurrency vendors able to submit queries to the account-identity service system 116. The registration front-end 112 illustratively comprises respective distinct sets of one or more web forms or other web pages accessible to the user device 102 and the cryptocurrency vendor devices 104 over the network 110. In other embodiments, different registration front-ends may be provided for the cryptocurrency users and the cryptocurrency vendors.

The authentication system 114 is configured to control access of the cryptocurrency users to cryptocurrency address registration functionality of the processing platform 108. It may additionally or alternatively be configured to control access of the cryptocurrency vendors to the account-identity service system 116. As in the case of the registration front-end 112, different authentication systems may be provided for the cryptocurrency users and the cryptocurrency vendors.

The account-identity service system 116 is assumed to be accessible to one or more authorized cryptocurrency vendors via the cryptocurrency vendor devices 104 and the network 110. The account-identity service system 116 is configured to utilize the stored user-address bindings of the database 118 to respond to queries received from the cryptocurrency vendors. In the present embodiment, a given one of the queries from a cryptocurrency vendor identifies a particular one of the users and a corresponding cryptocurrency address for which the particular user has requested to purchase an amount of the address-based cryptocurrency from the cryptocurrency vendor.

The account-identity service system 116 is further configured to generate a response to the given query that indicates whether or not the particular user has its user identity information bound to the corresponding cryptocurrency address for the requested purchase in one of the stored bindings of the database 118.

The account-identity service system 116 illustratively includes one or more application programming interfaces (APIs) that permit authorized cryptocurrency vendors to submit queries of the type described above.

The processing platform 108 is illustratively configured to store information characterizing the cryptocurrency vendor queries processed by the account-identity service system 116. Such information may be stored in association with the corresponding user-address bindings in the database 118, or may be stored in a separate database or alternative storage device, or in another type of memory. The term “database” as used herein is intended to be broadly construed so as to encompass all such storage arrangements. The stored information characterizing the processed queries and the stored bindings of the database 118 collectively serve to ensure that the cryptocurrency users that purchase amounts of the address-based cryptocurrency from the cryptocurrency vendor using payment cards issued by the financial institution cannot fraudulently repudiate those payment card purchases at a later date.

In some embodiments, the processing platform 108 is configured to generate a given one of the stored bindings of the database 118 based at least in part on one or more digitally-signed secrets associated with a given one of the users. Such a secret may comprise, for example, private information that is incorporated into a cipher-text generated by the user device 102, or other types of information that is typically maintained in secrecy by the user. The one or more secrets are digitally signed using a secret key of a cryptocurrency key pair of the given user. As noted above, the cryptocurrency key pair of the given user is more particularly associated with a corresponding cryptocurrency account of that user. Other arrangements for proving user identity can be used in other embodiments.

As a more particular example, the processing platform 108 may be configured to generate a given one of the stored bindings based at least in part on a cipher-text received for a given one of the users, the cipher-text being digitally signed using a secret key of a cryptocurrency key pair of the given user.

The user device 102 in FIG. 1 includes a cryptocurrency wallet 130. The cryptocurrency wallet 130 is assumed to generate the cipher-text and the digital signature on the cipher-text, although other arrangements are possible.

The processing platform 108 in this example is configured to verify correctness of the digital signature on the cipher-text relative to the public key of the cryptocurrency key pair of the given user, to decrypt the cipher-text using a secret key of the financial institution to obtain the payment card information, the other private information and the user identity information, to verify correctness of the information obtained from the decrypted cipher-text for the given user, to obtain the cryptocurrency address of the given user based at least in part on a public key of the cryptocurrency key pair of the given user, and to store a binding between the user identity information and the cryptocurrency address in the database 118.

In other embodiments, the processing platform 108 is configured to generate a given one of the stored bindings of the database 118 based at least in part on a public binding between an email address of a given one of the users and a cryptocurrency address of that user. For example, the processing platform 108 can be configured to generate the given stored binding based at least in part on a confirmation that the given user has registered with the processing platform 108 an email address that corresponds to the email address utilized in the public binding. Additionally or alternatively, the processing platform 108 can be configured to generate the given stored binding based at least in part on a confirmation that the given user has authenticated to the processing platform using a unique link sent by the processing platform to the email address utilized in the public binding.

It is to be appreciated that the particular arrangement of elements illustrated in FIG. 1 is presented by way of example only. Other embodiments can use different arrangements of devices, processing platforms, networks and other elements to implement functionality for securing cryptocurrency purchases as disclosed herein.

Cryptocurrencies, such as Bitcoin® or Ethereum®, are each is an instance of a distributed ledger, i.e., a publicly-readable tamper-proof record of a sequence of events. Early distributed ledgers, such as Bitcoin's, work as follows. Clients send transactions to miners, who package the transactions into blocks. Miners repeatedly propose new blocks to be applied to the ledger, and follow a global consensus protocol to agree on which blocks are chosen. Each block contains a cryptographic hash of the previous block, making it difficult to tamper with the ledger. The resulting distributed data structure, called a blockchain, defines the sequence of transactions that constitutes the distributed ledger.

Modern blockchain systems often interpose an additional software layer between clients and the blockchain. Client requests are directed to scripts, called smart contracts, that perform the logic needed to provide a complex service, such as managing state, enforcing governance, or checking credentials. Smart contracts can take many forms, but here we will use as an example a simplified form of the Ethereum model.

In general, Ethereum is an open software platform based on blockchain technology that enables developers to build and deploy decentralized applications. More specifically, Ethereum is a decentralized platform that runs smart contracts, i.e., applications that run exactly as programmed without any possibility of downtime, censorship, fraud or third party interference. These applications run on a custom built blockchain, a shared global infrastructure that can move value around and represent the ownership of property. This enables developers to create markets, store registries of debts or promises, move funds in accordance with instructions given long in the past (like a will or a futures contract) and many other things, all without a middle man or counter-party risk. On traditional server architectures, every application has to set up its own servers that run their own code in isolated silos, making sharing of data hard. If a single application is compromised or goes offline, many users and other applications are affected. On a blockchain, anyone can set up a node that replicates the necessary data for all nodes to reach an agreement and be compensated by users and application developers. This enables user data to remain private and applications to be decentralized like the Internet was supposed to work.

A smart contract resembles an object in a programming language. It manages long-lived state, which is encoded in the blockchain. The state is manipulated by a set of functions, analogous to methods in many programming languages. Functions can be called either directly by clients or indirectly by other smart contracts. Smart contract languages are typically Turing-complete. To ensure that function calls terminate, the client is charged for each computational step in a function call. If the charge exceeds what the client is willing to pay, the computation is terminated and rolled back.

When and where is smart contract code executed? There are two distinct circumstances. Each smart contract is first executed by one or more miners, nodes that repeatedly propose new blocks to append to the blockchain. When a miner creates a block, it selects a sequence of user requests and executes the associated smart contract code for each Ethereum transaction in sequence, transforming the old contract state into a new state. It then records both the sequence of transactions and the new state in the block, and proposes it for inclusion in the blockchain.

Later, when the block has been appended to the blockchain, each smart contract is repeatedly re-executed by validators: nodes that reconstruct (and check) the current blockchain state. As a validator acquires each successive block, it replays each of the transactions' contract codes to check that the block's initial and final states match. Each miner validates blocks proposed by other miners, and older block are validated by newly-joined miners, or by clients querying the contract state. Code executions for validation vastly exceed code executions for mining.

Existing smart contract designs limit throughput because they admit no concurrency. When a miner creates a block, it assembles a sequence of transactions, and computes a tentative new state by executing those transactions' smart contracts serially, in the order they occur in the block. A miner cannot simply execute these contracts in parallel, because they may perform conflicting accesses to shared data, and an arbitrary interleaving could produce an inconsistent final state. For Bitcoin transactions, it is easy to tell in advance when two transactions conflict, because input and output data are statically declared. For smart contracts, by contrast, it is impossible to tell in advance whether two contract codes conflict, because the contract language is Turing-complete.

Miners are rewarded for each block they successfully append to the blockchain, so they have a strong incentive to increase throughput by parallelizing smart contract executions. The present invention enables miners to execute contract codes in parallel by adapting techniques from Software Transactional Memory (STM): treating each invocation as a speculative atomic action. Data conflicts, detected at run-time, are resolved by delaying or rolling back some conflicting invocations. Treating smart contract invocations as speculative atomic actions dynamically discovers a serializable concurrent schedule, producing the same final state as a serial schedule where the contract functions were executed in some one-at-a-time order.

Existing STM systems are non-deterministic, i.e., if a later validator simply mimics the miner by re-running the same mix of speculative transactions, it may produce a different serialization order and a different final state, causing validation to fail incorrectly. Treating contract invocations as speculative transactions improves miners' throughput, but fails to support deterministic re-execution as required by validators.

However, the miner has already “discovered” a serializable concurrent schedule for those transactions. In the present invention, the miner records that successful schedule, along with the final state, allowing later validators to replay that same schedule in a concurrent but deterministic way. Deterministic replay avoids many of the miner's original synchronization costs, such as conflict detection and roll-back. Over time, parallel validation would be a significant benefit because validators perform the vast majority of contract executions. Naturally, the validator must be able to check that the proposed schedule really is serializable.

The present invention enables miners to speculatively execute smart contracts in parallel by using transactional boosting to permit non-conflicting smart contracts to execute concurrently. Moreover, the present invention enables miners to capture the resulting parallel execution in the form of a fork-join schedule to be executed by validators, deterministically, verifiably, and in parallel.

In Bitcoin and similar systems, transactions typically have a simple structure, distributing the balances from a set of input accounts to a set of newly created output accounts. In Blockchains such as Ethereum, however, each block also includes an explicit state capturing the cumulative effect of transactions in prior blocks. Transactions are expressed as executable code, often called smart contracts, that modifies that state. Ethereum blocks thus contain both transactions' smart contracts and the final state produced by executing those contacts.

The contracts themselves are stored in the blockchain as byte-code instructions for the Ethereum virtual machine (EVM). Several higher-level languages exist for writing smart contracts. In the present invention, Here, smart contracts as expressed in the Solidity language, although others may also be utilized. In general, Solidity is a contract-oriented programming language for writing smart contracts; it is used for implementing smart contracts on various blockchain platforms.

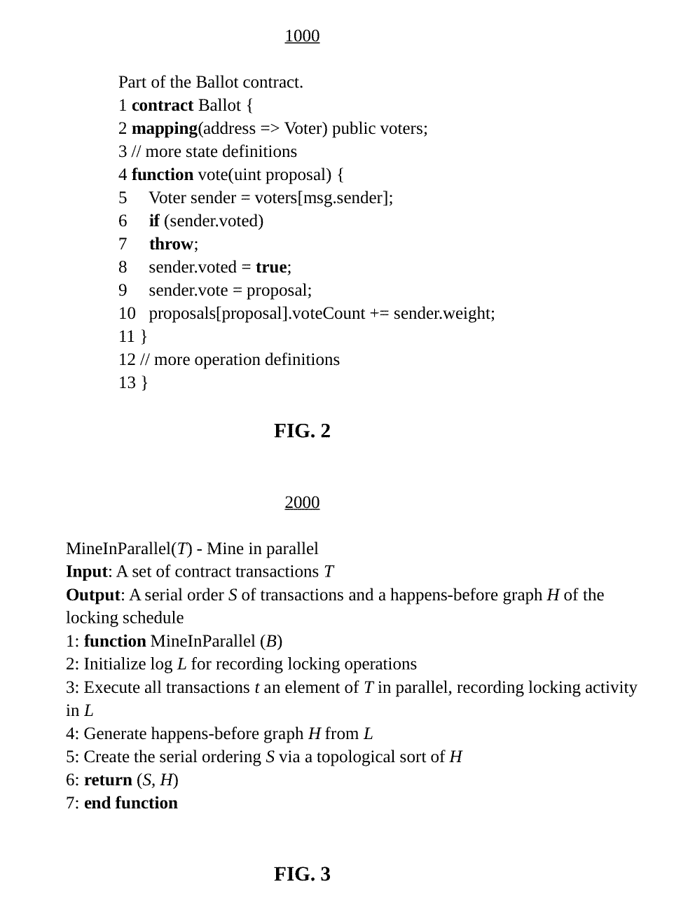

As shown in FIG. 2, an exemplary Solidity language listing 1000 is shown. Listing 1000 is part of the source code for an example smart contract that implements a ballot box. The owner initializes the contract with a list of proposals and gives the right to vote to a set of Ethereum addresses. Voters cast their votes for a particular proposal, which they may do only once. Alternatively, voters may delegate their vote. The contract keyword declares the smart contract (Line 1).

The contract's persistent state is recorded in state variables. For Ballot, the persistent state includes fields of scalar type such as the owner (omitted for lack of space). State variables such as voters (declared on Line 2) can also use the built-in Solidity type mapping which, in this case, associates each voter's address with a Voter data structure (declaration omitted for brevity). The keys in this mapping are of built-in type address, which uniquely identifies Ethereum accounts (clients or other contracts). These state variables are the persistent state of the contract.

Line 4 declares contract function, vote, to cast a vote for the given proposal. Within a function there are transient memory and stack areas such as sender. The function vote first recovers the Voter data from the contract's state by indexing into the voters mapping using the sender's address msg.sender. The msg variable is a global variable containing data about the contract's current invocation. Next, the sender.vote flag is checked to prevent multiple votes. Note that sequential execution is critical, i.e., if this code were natively run in parallel, it would be vulnerable to a race condition permitting double voting. Ethereum contract functions can be aborted at any time via throw, as seen here when a voter is detected attempting to vote twice. The throw statement causes the contract's transient state and tentative storage changes to be discarded. Finally, this Ballot contract also provides functions to register voters, delegate one's vote, and compute the winning proposal.

When a miner prepares a block for inclusion in the blockchain, it starts with the ledger state as of the chain's most recent block. The miner selects a sequence of new transactions, records them in the new block, and executes those their contracts, one at a time, to compute the new block's state. The miner then participates in a consensus protocol to decide whether this new block will be appended to the blockchain.

To ensure that each transaction terminates in a reasonable number of steps, each call to contract byte code comes with an explicit limit on the number of virtual machine steps that a call can take. (In Ethereum, these steps are measured in gas and clients pay a fee to the miner that successfully appends that transaction's block to the blockchain.)

After a block has been successfully appended to the blockchain, that block's transactions are sequentially re-executed by every node in the network to check that the block's state transition was computed honestly and correctly. (Smart contract transactions are deterministic, so each re-execution yields the same results as the original.) These validator nodes do not receive fees for re-execution.

To summarize, a transaction is executed in two contexts: once by miners before attempting to append a block to the blockchain, and many times afterward by validators checking that each block in the blockchain is honest. In both contexts, each block's transactions are executed sequentially in block-order.

Smart contract semantics is sequential, i.e., each miner has a single thread of control that executes one EVM instruction at a time. The miner executes each of the block's contracts in sequence. One contract can call another contract's functions, causing control to pass from the first contract code to the second, and back again. (Indeed, misuse of this control structure has been the source of well-known security breaches) Clearly, even sequential smart contracts must be written with care, and introducing explicit concurrency to contract programming languages would only make the situation worse. We conclude that concurrent smart contract executions must be serializable, indistinguishable, except for execution time, from a sequential execution.

There are several obstacles to running contracts in parallel. First, smart contract codes read and modify shared storage, so it is essential to ensure that concurrent contract code executions do not result in inconsistent storage states. Second, smart contract languages are Turing-complete, and therefore it is impossible to determine statically whether contracts have a data conflict.

In the present invention, miners execute contract codes as speculative actions. A miner schedules multiple concurrent contracts to run in parallel. Contracts' data structures are instrumented to detect synchronization conflicts at run-time, in much the same way as mechanisms like transactional boosting. If one speculative contract execution conflicts with another, the conflict is resolved either by delaying one contract until another completes, or by rolling back and restarting some of the contracts. When a speculative action completes successfully, it is said to commit, and otherwise it aborts.

Here we assume that state variables are restricted to predefined types such as scalars, structures, enumerations, arrays, and mappings. A storage operation is a primitive operation on a state variable. For example, binding a key to a value in a mapping, or reading from a variable or an array are storage operations. Two storage operations commute if executing them in either order yields the same result values and the same storage state. For example, in the address-to-Voter Ballot mapping in listing 1000, binding Alice's address to a vote of 42 commutes with binding Bob's address to a vote of 17, but does not commute when deleting Alice's vote. An inverse for a storage operation is another operation that undoes its effects. For example, the inverse of assigning to a variable is restoring its prior value, and the inverse of adding a new key-value pair to a mapping is to remove that binding, and so on. We assume herein that the run-time system provides all storage operations with inverses.

The virtual machine is in charge of managing concurrency for state variables such as mappings and arrays. Speculation is controlled by two run-time mechanisms, invisible to the programmer, and managed by the virtual machine: abstract locks, and inverse logs. Each storage operation has an associated abstract lock. The rule for assigning abstract locks to operations is simple: if two storage operations map to distinct abstract locks, then they must commute. Before a thread can execute a storage operation, it must acquire the associated abstract lock. The thread is delayed while that lock is held by another thread. Once the lock is acquired, the thread records an inverse operation in a log, and proceeds with the operation.

If the action commits, its abstract locks are released and its log is discarded. If the action aborts, the inverse log is replayed, most recent operation first, to undo the effects of that speculative action. When the replay is complete, the action's abstract locks are released.

An advantage of combining abstract locks with inverse logs is that the virtual machine can support very fine-grained concurrency. A more traditional implementation of speculative actions might associate locks with memory regions such as cache lines or pages, and keep track of old and versions of those regions for recovery. Such a coarse-grained approach could lead to many false conflicts, where operations that commute in a semantic sense are treated as conflicting because they access overlapping memory regions.

When one smart contract calls another, the run-time system creates a nested speculative action, which can commit or abort independently of its parent. A nested speculative action inherits the abstract locks held by its parent, and it creates its own inverse log. If the nested action commits, any abstract locks it acquired are passed to its parent, and its inverse log is appended to its parent's log. If the nested action aborts, its inverse log is replayed to undo its effects, and any abstract locks it acquired are released. Aborting a child action does not abort the parent, but a child action's effects become permanent only when the parent commits. The abstract locking mechanism also detects and resolves deadlocks, which are expected to be rare.

The scheme described here is eager, acquiring locks, applying operations, and recording inverses. An alternative lazy implementation buffers changes to a contract's storage, applying them only on commit.

A miner's incentive to perform speculative concurrent execution is the possibility of increased throughput, and hence a competitive advantage against other miners. Of course, the miner undertakes a risk that synchronization conflicts among contracts will cause some contracts to be rolled back and re-executed, possibly delaying block construction, and forcing the miner to re-execute code not compensated by client fees. Nevertheless, the experimental results reported below suggest that even a small degree of concurrent speculative execution pays off, even in the face of moderate data conflicts.

The speculative techniques discussed above for miners are no help for validators. Here is the problem. Miners use speculation to discover a concurrent schedule for a block's transactions, a schedule equivalent to some sequential schedule, except faster. That schedule is constructed nondeterministically, depending on the order in which threads acquired abstract locks. To check that the block's miner was honest, validators need to reconstruct the same (or an equivalent) schedule chosen by the miner.

Validators need a way to deterministically reproduce the miner's concurrent schedule. To this end, the present invention extends abstract locks to track dependencies, that is, who passed which abstract locks to whom. Each speculative lock includes a use counter that keeps track of the number of times it has been released by a committing action during the construction of the current block. When a miner starts a block, it sets these counters to zero.

When a speculative action commits, it increments the counters for each of the locks it holds, and then it registers a lock profile with the VM recording the abstract locks and their counter values.

When all the actions have committed, it is possible to reconstruct their common schedule by comparing their lock profiles. For example, consider three committed speculative actions, A, B, and C. If A and B have no abstract locks in common, they can run concurrently. If an abstract lock has counter value 1 in A's profile and 2 in C's profile, then C must be scheduled after A.

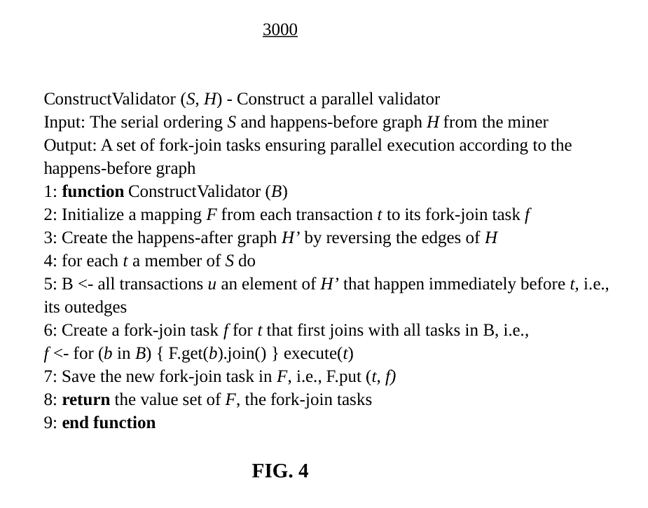

A miner includes these profiles in the blockchain along with usual information. From this profile information, validators can construct a fork-join program that deterministically reproduces the miner's original, speculative schedule. In FIG. 3, process 2000 illustrates a high-level sketch of the operation of the miner. By logging the locking schedule during parallel execution, the miner generates a happens-before graph of transactions according to the order in which they acquire locks and commit. A valid serial history is produced from a topological sort of this graph. In FIG. 4, process 3000 constructs the validator by scanning through the list of actions as they appear in the serial history. A fork-join task is created for each action and stored for lookup by its identifier. Each task will first lookup and join any tasks that must precede it according to the locking schedule before executing the action itself

The resulting fork-join program is not speculative, nor does it require inter-thread synchronization other than forks and joins. The validator is not required to match the miner's level of parallelism: using a work-stealing scheduler, the validator can exploit whatever degree of parallelism it has available. The validator does not need abstract locks, dynamic conflict detection, or the ability to roll back speculative actions, because the fork-join structure ensures that conflicting actions never execute concurrently.

To check that the miner's proposed schedule is correct, the validator's virtual machine records a trace of the abstract locks each thread would have acquired, had it been executing speculatively. This trace is thread-local, requiring no expensive inter-thread synchronization. At the end of the execution, the validator's VM compares the traces it generated with the lock profiles provided by the miner. If they differ, the block is rejected.

What is a miner's incentive to be honest about its fork-join schedule? A miner who publishes an incorrect schedule will be detected and its block rejected, but a miner may be tempted to publish a correct sequential schedule equivalent to, but slower than its actual parallel schedule, with the goal of slowing down verification by competing miners. Perhaps the simplest way to provide an incentive is to reward miners more for publishing highly parallel schedules (for example, as measured by critical path length). This reward could be part of a static “coinbase” transaction that creates currency, or client fees could be discounted for less parallel schedules. Because fork-join schedules are published in the blockchain, their degree of parallelism is easily evaluated. Such rewards must be calibrated to produce desired effects.

Concurrent calls to smart contract functions might leave persistent storage in an inconsistent state not possible after a serial execution. Instead, every concurrent execution permitted in the present invention is equivalent to some sequential execution. Because miners are free to choose the order in which contracts appear in a block, any sequential execution will do. Transactional boosting is serializable. A given execution of a contract's function involves a sequence of operations on storage objects. (The Ethereum gas restriction ensures this sequence is finite.) Recall that if two storage operations map to distinct abstract locks, then they commute. If another thread executes another sequence of operations, then if there are two operations that do not commute, then both threads will try to acquire the same lock, and one will be delayed until the other completes. (Deadlocks are detected and resolved by aborting one execution.) The result is a serializable execution.

We cannot guarantee that the schedule published by the miner is the same one that it executed, but we can guarantee the two are equivalent to a common sequential history. Validators replay the concurrent schedule published by the miner, and will detect if the schedule produces a final state different from the one recorded in the block, or if the schedule has a data race (an unsynchronized concurrent access).

Because the EVM is not multithreaded, present invention may be implemented using the Java Virtual Machine (JVM). Speculative actions are executed by the Scala Software Transactional Memory Library (ScalaSTM).

Examples of smart contracts are translated from Solidity into Scala, then modified to use the concurrency libraries. Each function from the Solidity contract is turned into a speculative transaction by wrapping its contents with a ScalaSTM atomic section. Solidity mapping objects are implemented as boosted hash tables, where key values are used to index abstract locks. Additionally, solidity struct types are translated into immutable case classes. Methods take a msg field to emulate Solidity contracts' global state, which includes details of the transaction, addresses of participants, and so on. Scalar fields are implemented as a single a boosted mapping.

The Solidity throw operation, which explicitly rolls back a contract execution, is emulated by throwing a Java runtime exception caught by the miner. In one embodiment of the present invention, abstract locks are implemented via interfaces exported by ScalaSTM, relying on ScalaSTM's native deadlock detection and resolution mechanisms.

Miners manage concurrency using Java's ExecutorService. This class provides a pool of threads and runs a collection of callable objects in parallel. A block of transactions in Ethereum is implemented as a set of callable objects passed to the thread pool. To generate locking profiles from the parallel execution, we instrument smart contracts to log when atomic sections start and end, as well as calls to boosted operations. From the log, we can encode the locking schedule as a happens-before graph for the validator. The validator transforms this happens-before graph into a fork-join program. Each transaction from the block is a fork-join task that first joins with all tasks according to its in-edges on the happens-before graph.

In other embodiments, one skilled in the art will appreciate that the speculative techniques disclosed here, for both mines and validators, are equally applicable to “permissioned” blockchain systems, where the participating nodes are admitted by an authority. In such permissioned systems, proof-of-work transaction confirmation is often replaced by a more efficient “byzantine fault-tolerant” protocol.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An information processing system comprising:
a user device supporting a cryptocurrency user;
cryptocurrency vendor devices, the cryptocurrency vendor devices comprising processing devices of one or more cryptocurrency vendors that offers an amount of cryptocurrency for sale to the cryptocurrency user;
blockchain processing devices, the blockchain processing devices comprising processing devices of one or more cryptocurrency miners that perform processing operations to maintain a public ledger in a form of a blockchain characterizing transactions involving a particular cryptocurrency, the blockchain processing devices enabling miners to speculatively execute smart contracts in parallel using atomic transactions through hardware and/or software to permit non-conflicting smart contracts to execute concurrently;
a processing platform associated with a financial institution that provides payment mechanisms; and
a network coupling the the user device, cryptocurrency vendor devices, blockchain processing devices and the processing platform.

2. The information processing system of claim 1 wherein the atomic transactions comprise transactional memory.

3. The information processing system of claim 1 wherein enabling miners to speculatively execute smart contracts in parallel results in lower latency whenever the block's contracts lack data conflicts

4. The information processing system of claim of claim 1 wherein the miners are incentivized to include in each block an encoding of a serializable parallel schedule that produced the block

5. The information processing system of claim 4 wherein the blockchain processing devices enable validators to convert a schedule into a deterministic, parallel fork-join program that allows the validators to validate the block in parallel.

6. The information processing system of claim 1 wherein the processing platform comprises:
a registration front-end;
an authentication system;
an account-identity service system; and
a database that stores bindings between user identity information and respective cryptocurrency addresses for users of an address-based cryptocurrency.

7. The information processing system of claim 6 wherein the registration front-end comprises respective distinct sets of one or more web forms or other web pages accessible to the user device and the cryptocurrency vendor devices over the network.

8. The information processing system of claim 6 wherein the authentication system is configured to control access of the cryptocurrency users to cryptocurrency address registration functionality of the processing platform.

9. The information processing system of claim 6 wherein the account-identity service system is configured to utilize the stored user-address bindings of the database to respond to queries received from the cryptocurrency vendors.

10. The information processing system of claim 1 wherein the processing platform comprises:
a processor;
a memory; and
a network interface.

11. The information processing system of claim 1 wherein the blockchain processing devices are permissioned blockchain processing devices.

12. A method comprising:
providing an information processing system, the information processing system comprising:
a user device supporting a cryptocurrency user;
cryptocurrency vendor devices, the cryptocurrency vendor devices comprising processing devices of one or more cryptocurrency vendors that offers an amount of cryptocurrency for sale to the cryptocurrency user;
blockchain processing devices, the blockchain processing devices comprising processing devices of one or more cryptocurrency miners that perform processing operations to maintain a public ledger in a form of a blockchain characterizing transactions involving a particular cryptocurrency;
a processing platform associated with a financial institution that provides payment mechanisms;
a network coupling the the user device, cryptocurrency vendor devices, blockchain processing devices and the processing platform; and
enabling miners to speculatively execute smart contracts in parallel using atomic transactions through hardware and/or software to permit non-conflicting smart contracts to execute concurrently.

13. The method of claim 15 wherein the blockchain processing devices are permissioned blockchain processing devices.

14. The method of claim 12 wherein the atomic transactions comprise transactional memory.

15. The method of claim 12 wherein enabling miners to speculatively execute smart contracts in parallel results in lower latency whenever the block's contracts lack data conflicts.

16. The method of claim of claim 12 wherein the miners are incentivized to include in each block an encoding of a serializable parallel schedule that produced the block

17. The method of claim 16 wherein the blockchain processing devices enable validators to convert a schedule into a deterministic, parallel fork-join program that allows the validators to validate the block in parallel.

18. The method of claim 12 wherein the processing platform comprises:
a registration front-end;
an authentication system;
an account-identity service system; and
a database that stores bindings between user identity information and respective cryptocurrency addresses for users of an address-based cryptocurrency.
